(19) United States
(12) Patent Application Publication
(10) Pub. No.: US 2002/0071147 A1
(43) Pub. Date: Jun. 13, 2002

(54) Method of automatically synchronously testing the infrared equipment of an electronic apparatus

(76) Inventors: Kuang-Shin Lin, Taipei (TW); Tong-S Chen, Taipei (TW); Feng-Shun Lu, Tientsin (CN)

Correspondence Address: BACON & THOMAS, 625 Slaters Lane - 4th Floor, Alexandria, VA, 22314, US

(21) Appl. No.: 09/733,985

(22) Filed: Dec. 12, 2000

(51) Int. Cl. H04B 10/00

(52) U.S. Cl. 359/110; 359/172

(57) ABSTRACT

A method of automatically synchronously testing the infrared equipment of an electronic apparatus having a transmitter, a receiver, and a system function module, the method including the step of setting an infrared transmission frequency document register table, the step of arranging the transmitting frequency of the infrared equipment subject to the set register table so as to keep the frequency of the transmitter in match with the frequency of the receiver, the step of driving the transmitter to transmit a data signal to the receiver, and the step of driving the receiver to automatically compare the data signal transmitted by the transmitter and to give comparison result back to the transmitter for enabling the tester to know the test result of the infrared equipment.

### BACKGROUND OF THE INVENTION

The present invention relates to a method of automatically synchronously testing the infrared equipment of an electronic apparatus, which automatically completes the procedure of testing the function of the infrared equipment of an electronic apparatus without the intrusion of man. The method saves much cost, and is suitable for use in a big quantity infrared equipment test environment.

Notebook computers become more and more popular for the advantages of high mobility and versatile functions. An infrared equipment is a standard attachment of an advanced notebook computer. Before sending out of the factory, the infrared equipment of a notebook computer must be tested. This test procedure is done by labor. The test procedure comprises the step of installing an infrared equipment in the notebook computer, the step of installing a drive program in the notebook computer for driving the infrared equipment, the step of using the infrared data transmitting interface provided by the internal operation system of the notebook computer to transmit selected data, and the step of comparing the correctness of the data transmitted so as to determine normal functioning of the infrared equipment. This test procedure requires much labor to complete. Because the test procedure is run by labor, the labor cost is high.

### SUMMARY OF THE INVENTION

The present invention has been accomplished to provide an infrared equipment automatic test method, which eliminates the aforesaid drawback. It is the main object of the present invention to provide a method of testing the infrared equipment of an electronic apparatus, which automatically synchronously completes the test procedure. It is another object of the present invention to provide a method of testing the infrared equipment of an electronic apparatus, which is suitable for use in a production line to save infrared equipment testing cost. The method of the present invention comprises the step of setting an infrared transmission frequency document register table, the step of arranging the transmitting frequency of the infrared equipment subject to the set register table so as to keep the frequency of the transmitter in match with the frequency of the receiver, the step of driving the transmitter to transmit a data signal to the receiver, and the step of driving the receiver to automatically compare the data signal transmitted by the transmitter and to give comparison result back to the transmitter for enabling the tester to know the test result of the infrared equipment

### BRIEF DESCRIPTION OF THE DRAWING

FIG. 1 is one part of operation flow chart of the present invention.

FIG. 2 is a subsequent part of the operation flow chart shown in FIG. 1.

### DETAILED DESCRIPTION OF THE PREFERRED EMBODIMENT

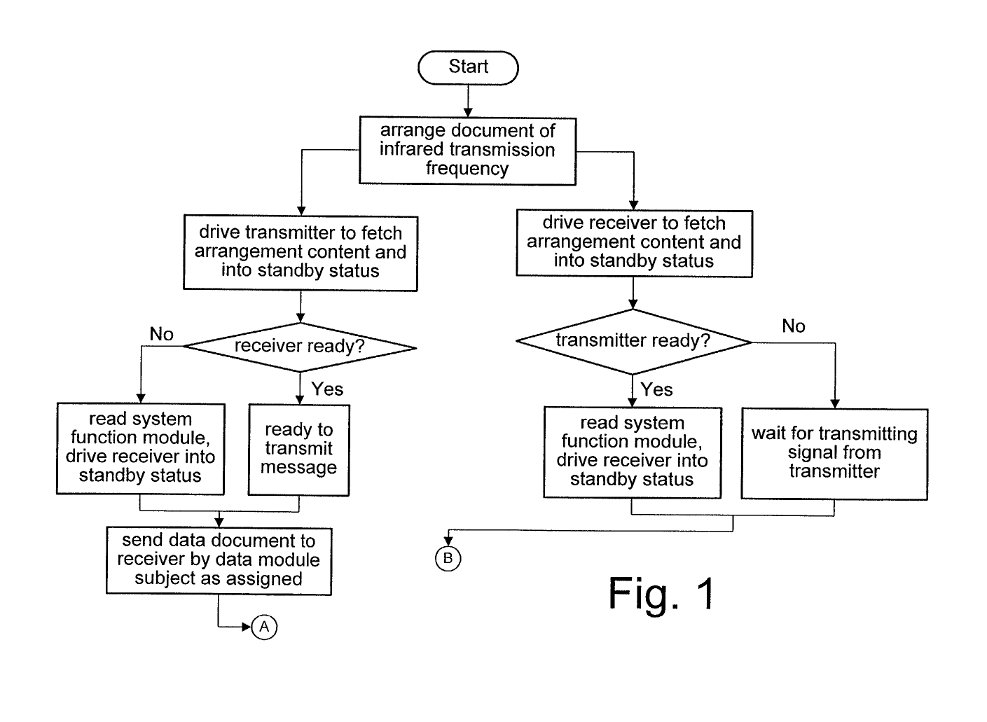

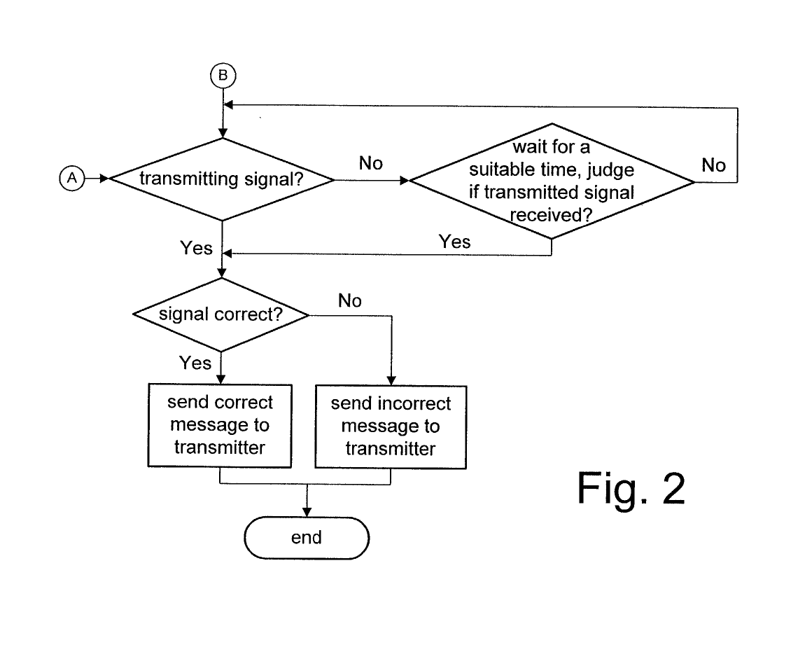

Referring to FIGS. 1 and 2, the invention is used in an electronic apparatus production line to automatically synchronously test the infrared transmission system of the electronic apparatus produced in the production line. According to the present preferred embodiment, the electronic apparatus is a notebook computer.

The infrared transmitting system comprises a transmitter, a receiver, and a system function module. The transmitter and the receiver are adapted to transmit and receive data signal. The system function module is adapted to control the operation of transmitting and receiving data signal, and to arrange the frequency of the infrared transmitting system subject to a register table built therein (not shown), for enabling the frequency of the signal transmitting operation of the transmitter and the frequency of the signal receiving operation of the receiver to be maintained in conformity with each other, so that the transmitter and the receiver are maintained in synchronous status to achieve normal data signal transmission.

The operation procedure of the present invention, as shown in FIGS. 1 and 2, comprises the steps of:

1) driving the transmitter of the infrared transmitting system into the standby status subject to the infrared transmitting frequency document arranged, and then driving the transmitter to fetch the content of the document arranged;

2) driving the receiver of the infrared transmitting system into the standby status subject to the infrared transmitting frequency document arranged, and then driving the receiver to fetch the content of the document arranged;

3) driving the transmitter to inquire message from the receiver and to judge if the receiver has been ready or not, so as to prepare transmitting message when the receiver is ready;

4) driving the receiver to inquire message from the transmitter and to judge if the transmitter has been ready or not, so as to read the system function module and to prepare receiving message when the transmitter is ready;

5) sending set data document to the receiver subject to one data module of the system function module after the transmitter and the receiver had been linked (the frequency between the transmitter and the receiver has been matched);

6) judging if there is data document transmitting signal at the receiver, and then comparing the correctness of the data document transmitted in case there is data document transmitting signal at the receiver, and then sending the data signal back to the transmitter when recognized, so as to let the tester know the result and to complete the test procedure;

7) reading the system function module if the receiver is not ready when enquiring message from the receiver, so as to drive the receiver into the receiving status;

8) waiting for signal from the transmitter if the transmitter is not ready when enquiring message from the transmitter;

9) judging again after a predetermined length of waiting time elapsed if there was no data document transmitting signal at the receiver, and then comparing the correctness of the data document signal transmitted in case there is data document transmitting signal at the receiver at this time, and then sending the correct signal back to the transmitter after recognition of the transmitted data document signal, so as to let the tester know the result and to complete the test procedure;

10) sending the signal back to the transmitter if the transmitted data document signal is incorrect, so as to let the tester know the result and to complete the test procedure;

11) waiting for the transmitter to transmit signal again when received no data document transmitting signal a certain length of time after waiting.

As indicated, by means of the set register table to arrange the infrared transmitting frequency of the infrared transmitting system, the frequency of the transmitter of the infrared transmitting system is kept matched with that of the receiver, and the receiver is driven to compare data signal transmitted by the transmitter and to send comparison result back to the transmitter so as to automatically synchronously complete the test. This test procedure saves much cost, eliminates human error, and is suitable for use in a big quantity infrared transmitting system test environment.

It is to be understood that the drawings are designed for purposes of illustration only, and are not intended for use as a definition of the limits and scope of the invention disclosed.

What the invention claimed is:

1. A method of automatically synchronously testing the infrared equipment of an electronic apparatus having a transmitter, a receiver, and a system function module, the method comprising the step of setting an infrared transmission frequency document register table, the step of arranging the transmitting frequency of the infrared equipment subject to the set register table so as to keep the frequency of the transmitter in match with the frequency of the receiver, the step of driving the transmitter to transmit a data signal to the receiver, and the step of driving the receiver to automatically compare the data signal transmitted by the transmitter and to give comparison result back to the transmitter for enabling the tester to know the test result of the infrared equipment.

2. The method of claim 1 wherein said system function module of said infrared equipment runs subject to the following steps during test of said infrared equipment:
(a) driving said receiver into standby status to receive signal subject to the arrangement of the infrared transmission frequency document of the register table, and then driving said receiver to fetch the content of the arrangement, and then driving said transmitter into the standby status to transmit signal subject to the arrangement of the infrared transmission frequency document of the register table, and then driving said transmitter to fetch the content of the arrangement;
(b) using one data module of said system function module to send the set data document to said receiver; and
(c) comparing the data document signal and sending the signal back to said transmitter, so as to let the tester know the test status and to complete the test procedure of the infrared equipment.

3. The method of claim 2 wherein, further comprising the step of driving said receiver into the standby status to receive signal if said receiver is judged not ready yet.

4. The method of claim 2, further comprising the step of driving said transmitter into the standby status to transmit signal if said transmitter is judged not ready yet.

5. The method of claim 2, further comprising the step of linking said transmitter and said receiver again a predetermined length of time after failure of linking between said transmitter and said receiver, and then judging if there is data document transmitting signal, and then comparing the correctness of the data document signal transmitted, and then sending the correct signal back to the transmitter for enabling the tester to know the test result.

6. The method of claim 5, further comprising the step of waiting for signal from the transmitter if there is no data document transmitting signal after linking between said transmitter and said receiver.

7. The method of claim 5, further comprising the step of sending the incorrect signal back to said transmitter for enabling the tester to know the test result if the data document signal is compared incorrect.

8. The method of claim 1, wherein said electronic apparatus is a notebook computer.
